(19) United States
(12) Patent Application Publication
(10) Pub. No.: US 2011/0191086 A1
(43) Pub. Date: Aug. 4, 2011

(54) MODEL OF ACCOMMODATIVE INTRAOCULAR LENS

(75) Inventors: Wayne B. Callahan, Abingdon, VA (US); Anna S. Hayes, Newton Centre, MA (US)

(73) Assignee: Anew Optics, Inc., Newton Centre, MA (US)

(21) Appl. No.: 13/020,964

(22) Filed: Feb. 4, 2011

Related U.S. Application Data
(60) Provisional application No. 61/301,418, filed on Feb. 4, 2010.
(60) Provisional application No. 61/307,506, filed on Feb. 24, 2010.

(51) Int. Cl. G06G 7/60

(52) U.S. Cl. 703/11

(57) ABSTRACT

The invention is directed to a model comprising a diagrammatical and geometric simplification of the components of the natural eye whose functionality is fundamental to the successful performance of a pseudo-aphakic accommodative lens. This model allows for a functional correlation of each component of the ophthalmic device with the patient needs. The eye model was developed to show the movement of the eye from the distance vision to the near vision positions through multiple phases of accommodative motion. The inventive model was developed using a mathematical series of formulas to calculate each of the components of focal accommodation in a human eye, quantify these, and construct the pictorial ramifications of such calculations. The inventive model presents an analysis of accommodative dynamics in the human eye with the natural lens in place. The inventive model also demonstrates the accommodative dynamics with a proprietary IOL in place of the natural lens and situated within the lens capsule.

### REFERENCE TO RELATED APPLICATIONS

This application claims priority to U.S. Provisional Application No. 61/301,418, filed Feb. 4, 2010, and U.S. Provisional Application No. 61/307,506, filed Feb. 24, 2010. The entirety of both of these provisional applications is hereby incorporated by reference.

### BACKGROUND

1. Field of the Invention

This invention is directed to a model of an accommodative intraocular lens (IOL) for insertion in a human eye, and to methods for inserting and utilizing an accommodative IOL. In particular, the invention is also directed to an accommodative intraocular lens modeled by the invention.

2. Description of the Background

FIG. 1 is a diagram of a human eye. The clear structure covering the central portion of the eye is the cornea. The cornea functions much like a window in allowing light to penetrate the eye. The structure of the cornea is convex, and the inner and outer indices of curvature and implied circular radii are such as to have the cornea function as the first part of the eye to refract (bend) incoming light, as shown in FIG. 2. This directs the light rays to the lens of the eye through the pupil of the eye, which is actually an aperture in the iris.

The iris is the visually evident colored portion of the eye which changes size in response to varying stimuli, each of which can have an influence on IOL performance. For example, the iris responds to conditions of intense, bright light by moving toward the center of the eye, thus contracting the diameter of the pupil and effectively allowing less light to penetrate to the lens. Conversely, in dim light or darkness, the iris draws away from the center of the eye, dilating the pupil and allowing more light to penetrate the lens. In addition, generally the pupil contracts when a person uses near vision to focus on close objects, and is more dilated when a person focuses on a distant object. The extent of iridial motion and alteration in pupil diameter varies from individual to individual, and also varies as a function of age, medication, medical condition, and neural and ophthalmic functionality. Beyond controlling the aperture of the pupil and thus the amount of light to penetrate the lens, the iris does not serve to bend the light rays.

Behind the iris is the natural lens of the eye. The natural lens is made up of an outer membrane much like a kidney or lung, but more delicate. The outer membrane is clear, and its function is to preserve certain indices of curvature on both the anterior and posterior capsular surfaces such as to bend light and direct such light toward the retina. Inside the capsule is the natural lens, a clear, soft, crystalline material that transfers light. The lens material becomes denser and harder with age, as lens cells continue to grow within the capsule. The aggregation of lens cellular material over time is considered one of the primary causes of presbyopia and, subsequently, of cataracts, as the material ultimately becomes too dense to maintain its clarity and transparency and begins to become cloudy with compressed lens cells. The functional elasticity of the lens and lens capsule is fundamental to focal accommodation. Thus, in older patients, one may anticipate the need for corrective lenses to provide focal capabilities as the accommodative motion of the natural lens is inhibited by increasing density and/or decreasing elasticity of the crystalline lens material.

The natural lens is centered behind the iris and in front of the retina. This position is maintained through accommodative states by a network of zonules, fine hair like fibers that have one end circumferentially attached to the capsule, while the other end affixes to the ciliary body, a muscular structure at the outer circumference of the inner eye. Two sets of zonules attach to the lens capsule, one set on the anterior surface of the capsule at a distance from the capsular equator, and the other on the posterior surface of the capsule, also at a distance from the capsular equator. The second end of the posterior zonules and the anterior zonules pass in close proximity and may touch at a point along the ciliary body. That point of contact is called the ciliary point. The zonules then affix to the ciliary body some distance from the ciliary point. The zonules are set closely enough together so as to provide an equal tensioning and positioning force around the entire lens capsule. A third set of zonules affixes at the posterior of the ciliary body and attaches to the outer circumference of the inner eye within the vitreous humor.

The ciliary body, in addition to containing the ciliary muscle, which controls the force on the zonules to control accommodation, controls intraocular pressure and produces aqueous fluid into the eye anterior of the natural lens, which feeds nutrients to other components of the eye, maintains hydration, and irrigates and cleanses the eye by moving any particulates to the trabecular meshwork anterior of the iris, where these particles pass into Schlemm's canal, and are removed. The effective motion of the ciliary body to cause changes in the position and shape of the natural lens is the principal force of focal accommodation; in response to neural prompts, the ciliary body engorges with blood. This moves the entire ciliary body anteriorly in the eye, and locates the ciliary point posteriorly and toward the center of the eye, which allows the zonules to move forward also, the result of which is a discernable movement of the nucleus of the natural lens, as the entire lens relocates anteriorly and the curvature of both the anterior and posterior surfaces of the lens increases. The lens in near focal accommodative state is closer to the iris at its anterior capsule, and thicker through the posterior capsule. Moreover, the centering of the ciliary point, accompanied by a slight posterior tilt to the ciliary point, is possibly a result of the restraining force on the ciliary body of the third set of zonules. This exerts a reining pressure on the anterior zonules which causes the anterior zonules to prevent the lens capsule from significantly penetrating the iridial plane, while also preserving an index of curvature such as to remain in focal sympathy with the posterior capsule and the surface of the cornea throughout the accommodative process. In all stages of accommodation, the attachment points of the zonules to the capsule and the ciliary body remain the same, and the total lens capsule circumference and volume do not change.

Although much information exists about the mammalian eye, a need exists for a model that can design an accommodative intraocular lens.

### SUMMARY

The present invention overcomes the problems and disadvantages associated with current strategies and designs and provides a model of an accommodative intraocular lens, as well as methods for insertion and utilization of an accommodative intraocular lens in a human eye, and IOLs designed by the model.

One embodiment of the invention is directed to a system to design a pseudo-aphakic accommodative lens for insertion into a human eye. The system is comprised of a processor, an input device and an output device in communication with the processor, and software executing on the processor. The software determines at least one characteristic of focal accommodation in the eye from the input device, processes the at least one characteristic of the eye, and outputs a computerized model of a accommodative intraocular lens (IOL). The pseudo-aphakic accommodative lens is designed from the computerized model.

Preferably at least one characteristic is chosen from an axial length of the eye, a position of the nucleus of a natural lens in the eye, a distance from the apex of the cornea of the lens, an index of curvature of the cornea, presence of scar tissue, and age and lifestyle of a patent. In the preferred embodiment, at least on characteristic is calculated mathematically from images of a human eye with imaging technology. The imaging technology is preferably an MRI.

In the preferred embodiment, the model depicts movement of the eye from a distance vision position to a near vision position. Preferably the model comprises a plurality of graphic images. The plurality of graphic images preferably depict changes in at least one of a ciliary body, a position of the zonules, and location and configuration of a natural lens as the eye moves from the distance vision position to the near vision position.

Preferably a slope of a zonule at an attachment point to a capsule is modeled as tangential to a capsular arch at the attachment point and perpendicular to a radius of curvature of the capsule. In the preferred embodiment, the maximum accommodation of the eye is modeled as six diopters or more. The overall length of anterior zonules is preferably modeled as the same for both distance and near positions and the volume of a lens capsule is preferably modeled as constant.

Another embodiment of the invention is directed to a method of designing with a computerized model a pseudo-aphakic accommodative lens for insertion into a human eye. The method includes the steps of determining at least one characteristic of focal accommodation in the eye, processing the at least one characteristic of the eye, forming the computerized model of a accommodative intraocular lens (IOL), and designing the pseudo-aphakic accommodative lens based on the model formed.

In the preferred embodiment, at least one characteristic is chosen from an axial length of the eye, a position of the nucleus of a natural lens in the eye, a distance from the apex of the cornea of the lens, an index of curvature of the cornea, presence of scar tissue, and age and lifestyle of a patent. Preferably at least on characteristic is calculated mathematically from images of a human eye taken with imaging technology. The imaging technology is preferably an MRI.

In the preferred embodiment, the computerized model depicts movement of the human eye from a distance vision position to a near vision position. The computerized model preferably comprises a plurality of graphic images. Preferably, the plurality of graphic images depict changes in at least one of a ciliary body, a position of the zonules, and location and configuration of the natural lens as the eye moves from the distance vision position to the near vision position.

Preferably, a slope of a zonule at an attachment point to a capsule is modeled as tangential to a capsular arch at the attachment point and perpendicular to a radius of curvature of the capsule. The maximum accommodation of the eye is preferably modeled at six diopters or more. Preferably the overall length of anterior zonules is modeled as the same for both distance and near positions and the volume of a lens capsule is modeled as constant.

Another embodiment of the invention is directed to computer readable media containing program instructions for determining a computerized model that designs a pseudo-aphakic accommodative lens for insertion into a human eye. The computer readable media causes a computer to obtain at least one characteristic of focal accommodation in the eye, process the at least one characteristic of the eye, and form the computerized model of a accommodative intraocular lens (IOL) based on the processed at least one characteristic of the eye.

In the preferred embodiment, at least one characteristic is chosen from an axial length of the eye, a position of the nucleus of a natural lens in the eye, the distance from the apex of the cornea of the lens, the index of curvature of the cornea, the presence of scar tissue, and age and lifestyle of the patent. Preferably at least on characteristic is calculated mathematically from images of the human eye. Preferably taken with an MRI.

In the preferred embodiment, the model depicts the movement of the eye from a distance vision position to a near vision position. Preferably the model comprises a plurality of graphic images. The plurality of graphic images preferably depict changes in at least one of a ciliary body, a position of the zonules, and location and configuration of the natural lens as the eye moves from the distance vision position to the near vision position.

Preferably a slope of a zonule at an attachment point to a capsule is modeled as tangential to a capsular arch at the attachment point and perpendicular to a radius of curvature of the capsule. In the preferred embodiment, the maximum accommodation of the eye is modeled at six diopters or more, the overall length of anterior zonules is modeled as the same for both distance and near positions, and a volume of a lens capsule is modeled as constant.

Other embodiments and advantages of the invention are set forth in part in the description, which follows, and in part, may be obvious from this description, or may be learned from the practice of the invention.

### DESCRIPTION OF THE FIGURES

The invention is described in greater detail by way of example only and with reference to the attached drawings, in which:

FIG. 1 is diagram of the structure of a natural eye.

FIG. 2 is a diagram depicting how light is refracted within a natural eye.

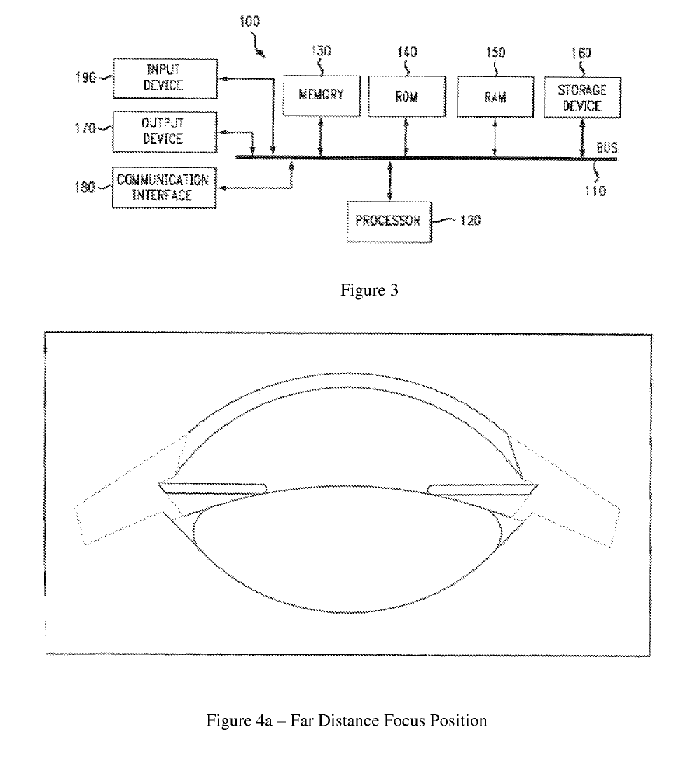

FIG. 3 is a schematic of an embodiment of the system of the invention.

FIGS. 4a-4f are models of natural eyes and IOLs at different focal positions.

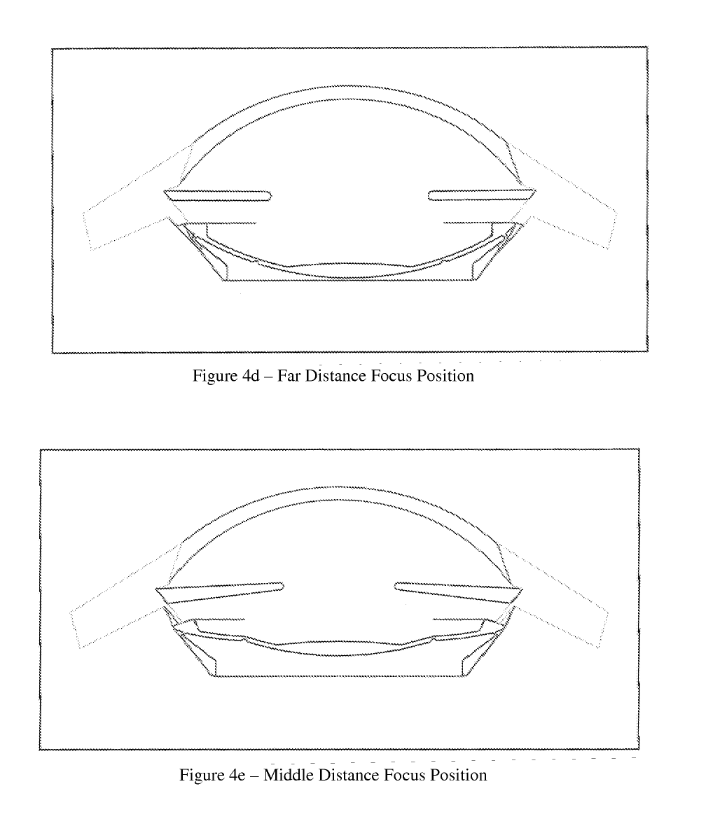

FIG. 5 is an MRI of a human eye.

FIGS. 6a and 6b are diagrams of zonule attachment points.

### DESCRIPTION OF THE INVENTION

As embodied and broadly described herein, the disclosures herein provide detailed embodiments of the invention. The disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

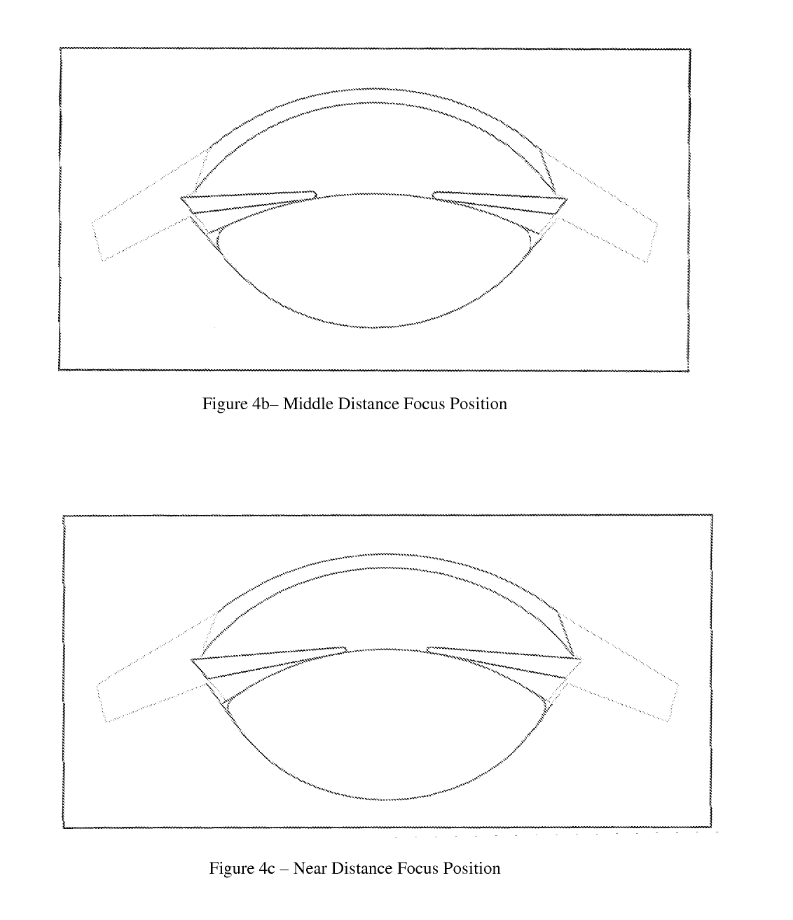

With reference to FIG. 3, an exemplary system includes at least one general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, a computer server, or a wireless devices, including wireless Personal Digital Assistants (“PDAs”) (e.g., PALM™ VII, Research in Motion's BLACKBERRY™, Apple's IPHONE™), wireless web-enabled phones, other wireless phones, etc.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can be one or more of a number of output mechanisms known to those of skill in the art, for example, printers, monitors, projectors, speakers, and plotters. In some embodiments, the output can be via a network interface, for example uploading to a website, emailing, attached to or placed within other electronic files, and sending an SMS or MMS message. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

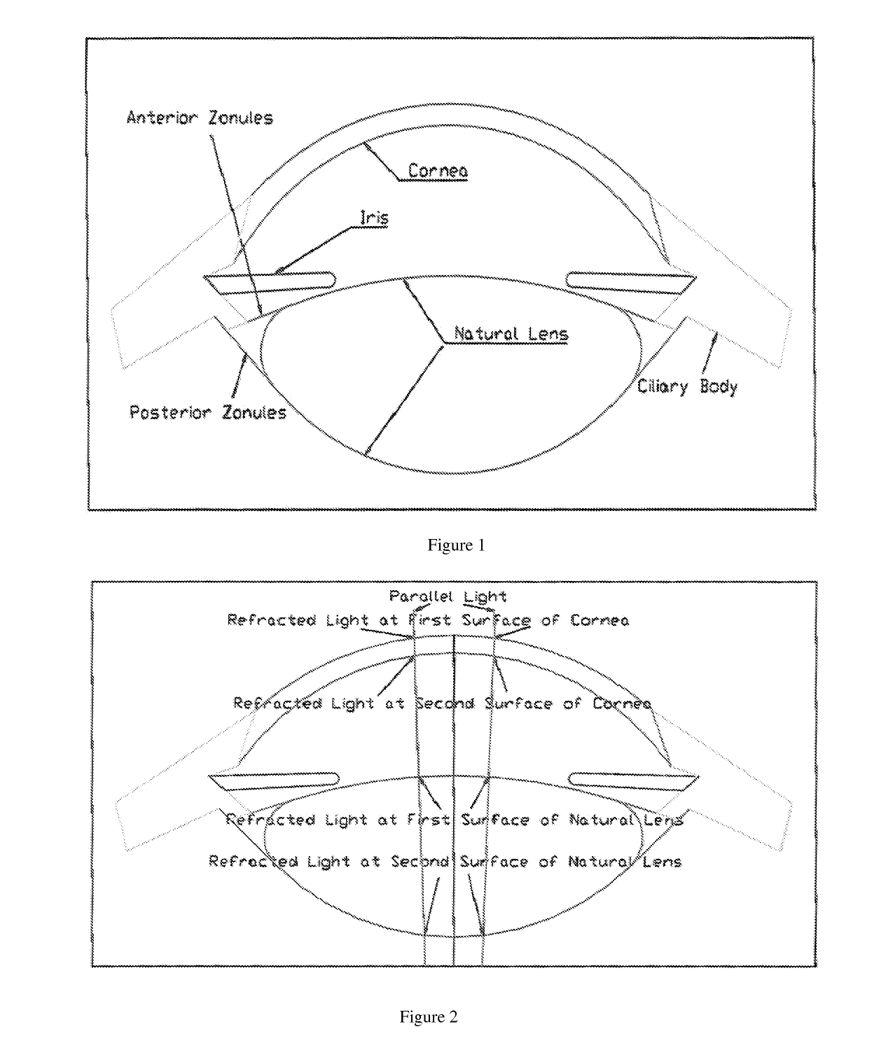

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The inventive computer model is based upon a diagrammatical and geometric simplification of the components of the natural eye whose functionality is fundamental to the successful performance of a pseudo-aphakic accommodative lens. Further, understanding the functional correlation of each component will assist the ophthalmic device designer in establishing proper sizing and lens power criteria to meet patient needs and individual specifications more successfully.

One embodiment of the invention is directed to a computer model of an accommodative intraocular lens (IOL) for insertion in a human eye. A computer eye model was developed to show the movement of the eye from the distance vision to the near vision positions through multiple phases of accommodative motion. The inventive model was developed using a mathematical series of formulas to calculate each of the components of focal accommodation in a human eye, quantify these, and construct the pictorial ramifications of such calculations. The inventive model presents an analysis of accommodative dynamics in the human eye with the natural lens in place. The inventive model also demonstrates the accommodative dynamics with a proprietary IOL in place of the natural lens and situated within the lens capsule.

The purposes of the inventive model are several-fold. The first intention of the model is to provide a framework for the design of new intraocular lenses with respect to, among other issues, positioning of the IOL within the lens capsule, haptic designs and configurations, overall sizing of the lens optic and haptic, and anticipated accommodative performance. The second intention of the model is to evaluate, compare and contrast new and existing IOL designs so as to seek to explain the accommodative functionality of each, and establish a rationale for the actual versus stated intended performance of each lens. This is particularly important when one considers that any lens in the market today may not perform equally in all patients, and ophthalmologists are challenged to identify the precise reason for performance shortfalls. The third intention of the model is to provide a mechanism for forecasting long-term performance of any IOL, identifying specific stress factors of each IOL and providing a precise range of risk factors associated in particular with that lens. This can serve as a critical diagnostic tool for ophthalmologists working with patients to determine what lens is best for each, and balancing the risks and rewards of each IOL.

Another intention of the inventive model is to provide a platform for ocular diseases related to cataract or lens replacement surgery. Another intention of the inventive model is to anticipate and analyze the performance of anterior chamber phakic IOLs and the processes of fixation within the anterior chamber. Another intention of the inventive model is to anticipate and measure the performance of extra-capsular posterior chamber IOLs, whether phakic or aphakic, based upon the haptic design of such IOLs and the accommodative dynamics of the eye as demonstrated in the model. Another intention is to provide sizing and positioning guidance and assistance to ophthalmologists with respect to different configurations of natural eyes so as to increase and optimize the odds of satisfactory performance of the IOL selected for that patient. Another intention is to use the model for further analysis of the eye, relating to dynamic changes in the volume of the aqueous humor attendant upon accommodation, pressure variations, functionality and dynamic motion of the iris, the trabecular meshwork, the ciliary body, the ciliary sulcus, and the vitreous humor, among others. Another intention of the inventive model is to provide an analytical framework wherein the mass of the intended IOL can be analyzed to assess short, medium and long term performance.

The developed IOLs utilizing this analytical method, provide the patient perfect or almost perfect distance vision while allowing the patient to read a Jaeger Number One (J-1) near vision (equivalent to the small print on the face of a wristwatch, or 0.75 mm tall at a distance of 14 inches from the eye) without any additional reading aides. The actual power of the IOL is, in part, determined by the axial length of the eye, which for hyperopes is shorter and for myopes is longer than normal controls, the position of the nucleus of the natural lens in the eye and its distance from the apex of the cornea, the configuration, or index of curvature of the cornea, and the presence in each patient of any scar tissue or other effects of any prior ophthalmic surgery or injury, including LASIK procedures. Lower powered IOLs are typically used in eyes with a longer axial length and for a given amount of movement within the eye would yield less accommodation. For the development of a basic mathematical model, an axial length of 25 millimeters was chosen to achieve a ‘worst case’ for accommodation, indicating that, in order for an eye of this size to adjust to the focal parameters set forth as the functional end point of the desired developed IOLs, the designed lens would need to move a greatest distance in an eye with an axial measurement of 25 mm, the normal axial length of an eye being in the range of 22 mm to 23 mm.

### Description of the Model:

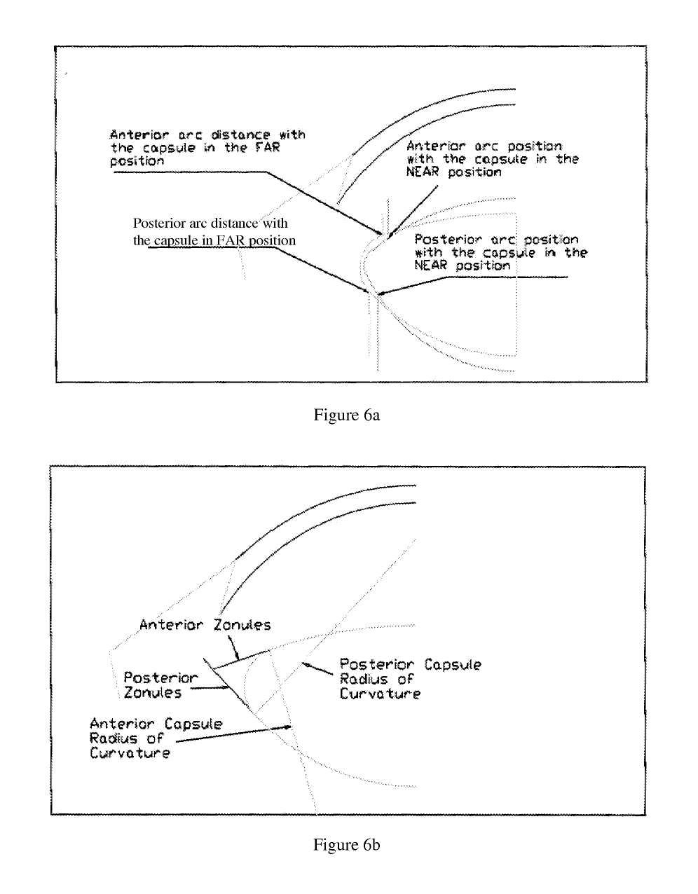

To create the inventive model, a computer determines at least one characteristic of focal accommodation in the eye. Characteristics can include, but are not limited to, the axial length of the eye, the position of the nucleus of the natural lens in the eye, the distance from the apex of the cornea of the lens, the index of curvature of the cornea, presence of scar tissue, and age and lifestyle of a patent. Once the characteristics of focal accommodation in the eye are determined, the computer processes the at least one characteristic to form a computerized model of an accommodative intraocular lens, which can be used in designing a pseudo-aphakic accommodative lens. Preferably, the computer outputs a plurality of graphic images produced from mathematical calculations showing a simplification of the components of the natural eye and/or an IOL. The component can include, but are not limited to, the varying manifestations of the changes in the ciliary body, the position of the zonules, and the location and configuration of the natural lens, see FIGS. 6a-6f showing a selection of graphic images where FIGS. 6a-6c are models of a natural eye and FIGS. 6d-6f are models of a IOL. While there are preferably fifteen graphic images, more or fewer graphic images can be produced.

### Analysis of the Inventive Model

The normal eye functions for distance vision by allowing parallel light rays to enter the cornea where they are initially refracted (bent) in a uniform manner circumferentially around the cornea. Each ray then travels to the anterior surface of the natural lens that again refracts the light and sends it on to the posterior surface of the natural lens, which brings the light to focus on the retina at a point. The retina receives the focused light and transmits it to the brain in the form of electrical pulses.

The anterior and posterior surfaces of the natural lens are portions of a circle and refract light. The zonules attach to the capsular surfaces tangential to that surface and perpendicular to the radius of curvature for each surface.

It is well known that pupils in younger patients dilate naturally to as large as eight millimeters. Since the patients with larger pupils do not have vision impaired by the zonules it is safe to believe the zonules attach distally close to the end of each optical surface, leaving at least a 4 mm radius of clear optical space from the center of the eye.

The depth of the anterior chamber, which is defined as the space between the inside of the corneal endothelium, and the anterior apex of the natural lens of the eye, is measurable and falls within a range of known values.

The surfaces of the natural lens consist of two optical arcs—of which one is the anterior optical arc, the second is the posterior optical arc—and two non-optical arcs that are the end sections that tangentially connect the two optical arced surfaces. The two end sections are defined as the areas between the tangential connections to the optical surfaces. The connection points of the zonules at the anterior and posterior capsular surfaces are either near the arc junctions or proximally toward the prime meridian, or equator, of the eye.

The circumference of the natural lens capsule around an axis perpendicular to the prime meridian of the eye must be the same in both the distance and near positions of the capsule, and in all intermediate stages of accommodation.

The zonules nearer the prime meridian must be perpendicular to the radius of curvature at that point. This is true for both the anterior and posterior zonules.

The arc distance from the prime meridian to the zonule attachment point is the same for the anterior surfaces regardless of whether the eye is in the distance or near positions. Likewise the same is true for the posterior chamber in both positions.

At near vision, the image for which the light rays penetrate the eye is much closer to the eye than at distance vision. This naturally means that the angle at which the light image enters the eye will be farther from the parallel plane at which an object on the horizon's light image will enter the eye. The rays of near images must be refracted more than distant parallel light rays and will require some magnification of the image to allow the brain to interpret that image with clarity. The accepted size of the image on the retina for reading seems to be 0.025 millimeters. To achieve that magnification the natural lens changes shape such that the thickness of the lens is greater and the radius of curvature of each surface is less. In a normal eye, it appears that to achieve a 0.025-millimeter circle of accommodation, the eye must create four diopters of accommodation. Other factors can be considered to evaluate the optimum extent of accommodation in a juvenile or young adult eye. For example, it appears that in shorter eyes in juveniles, the extent of accommodation may meet or exceed six diopters and, in certain cases, reach upwards of nine diopters. The IOL design of the invention takes into consideration both the natural configuration of the patient's eye as well as the age and lifestyle of the pseudo-aphakic lens recipient. Thus, the invention does not simply define the accommodative performance of the IOL by the limitations of the design, the design also provides for the ophthalmologist's judgment of the optimal accommodative range for that particular recipient.

### Mathematics of the Inventive Model

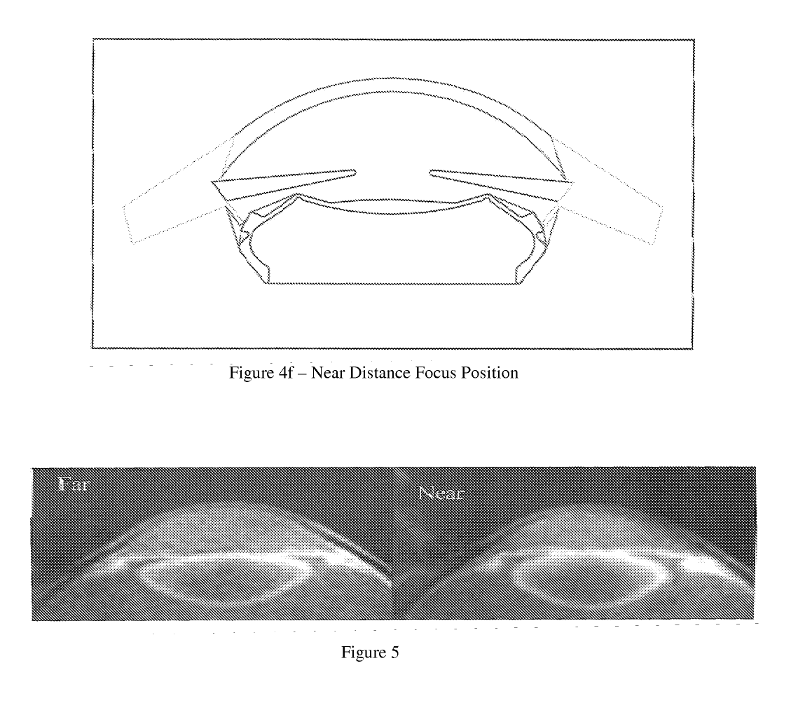

In applying the underlying logic applicable to the inventive model, certain assumptions were made for the purpose of arriving at a single model to meet the intentions stipulated in the summary of the invention. As an approximation of a normal eye, an MRI of an eye in both the distance and near positions was studied, see FIG. 5; however, the final numbers used were selected based upon mathematical calculations. A ray tracing was developed in both the distance and near positions mathematically.
1. An axial length of 25 millimeters was used.
2. The optical arc distances for both distance and near vision were calculated. The shorter of the arc distances between the distance and near positions was chosen as the zonule attachment point to the capsule. This was assumed to be true for both capsular arc surfaces. See FIGS. 6a and 6b.
3. Selected junction angles for each surface were calculated. The zonules nearest the prime meridian, or equator, of the natural lens capsule (anteriorly and posteriorly) attach tangential to the radius of the attached surface of the natural lens.
4. Since the zonular attachment point is fixed to the capsule, the linear distance around the arc from the prime meridian (PM) to the zonular attachment point is the same either in the distance or near positions.
5. The fixation rings are near the proximal end of the anterior and posterior arc distance. For the purpose of simplicity only one zonule is shown, but the zonule density is such as to form a mat or carpet effect.
6. The contact points of the zonules to the capsular surfaces were calculated such that the slope of the zonule at the attachment point to the capsule is tangential to the capsular arc at that point and perpendicular to the radius of curvature. This correlation of zonule to capsule was maintained throughout the varying phases of accommodation, on the understanding that if the zonules were not tangential. This may create aberrational stress on the capsule and distort the radius of curvature until equilibrium is achieved once again.
7. In each iteration of the model, the radius of curvature for each surface varied to allow the circumferences and the volumes of the capsule to be the same.
8. To achieve the most desirable relationship the radius of each surface varied to where the maximum accommodation for the eye model was over six diopters. (in shorter eyes the amount of accommodation in adolescences may be significantly higher).
9. With radii selected to allow for constant circumferences and volumes the resulting angles at the zonule connection points were projected.
10. Since the zonules are perpendicular to the radius of curvature of the surface at the point of attachment for each surface, equations were written to determine the ciliary body point, bearing in mind that the actual attachment location of the zonules to the ciliary body is at a point anterior to the ciliary body point, though distally farther from the lens prime meridian.
11. The attachment point of the zonules to the ciliary body is very close to being the same for the anterior and posterior zonules.
12. The arc distance from the prime meridian to the zonule connection on the anterior surface is the same for the natural lens in both the distance and near positions.
13. The overall length of the anterior zonules is the same for both the distance and near positions.
14. The distance from the zonular-capsular attachment point to the ciliary point varies in conjunction with the engorgement of the ciliary body, and, as such, the zonular distance from the ciliary point and the ciliary body distance from the prime meridian of the capsule will vary so as to provide for constant overall length of the zonules.
15. The same principle applies to the posterior capsule as related to the zonules and the ciliary body.
16. The arcs of the anterior, posterior, and end radius surfaces were calculated and added together to determine the circumference of the natural lens.
17. The volume of the capsule may also be a constant. To determine the volume the cross-sectional area of the small end partial sphere was calculated, as was the center of gravity with the results allowing for the calculation of the volume.
18. The area and center of gravity were determined to quantify the triangle between the end sphere and the central disc.
19. Volume calculations were made for the anterior and posterior partial spheres as well as for the central disc.
20. To achieve the desired balance between the circumferences and the volumes, certain radii were decreased so as to maintain a constant capsular circumference and volume. The resultant was an overall accommodation of at least six diopters.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the invention indicated by the following claims.

1. A system to design a pseudo-aphakic accommodative lens for insertion into a human eye comprising:
a processor;
an input device in communication with the processor;
an output device in communication with the processor; and
software executing on the processor, wherein the software:
determines at least one characteristic of focal accommodation in the eye from the input device;
processes the at least one characteristic of the eye; and
outputs a computerized model of a accommodative intraocular lens (IOL), wherein the pseudo-aphakic accommodative lens is designed from the computerized model.

2. The system of claim 1, wherein at least one characteristic is chosen from an axial length of the eye, a position of the nucleus of a natural lens in the eye, a distance from the apex of the cornea of the lens, an index of curvature of the cornea, presence of scar tissue, and age and lifestyle of a patent.

3. The system of claim 1, wherein at least on characteristic is calculated mathematically from images of a human eye with imaging technology.

4. The system of claim 3, wherein the imaging technology is an MRI.

5. The system of claim 1, wherein the model depicts movement of the eye from a distance vision position to a near vision position.

6. The system of claim 5, wherein the model comprises a plurality of graphic images.

7. The system of claim 6, wherein the plurality of graphic images depict changes in at least one of a ciliary body, a position of the zonules, and location and configuration of a natural lens as the eye moves from the distance vision position to the near vision position.

8. The system of claim 1, wherein a slope of a zonule at an attachment point to a capsule is modeled as tangential to a capsular arch at the attachment point and perpendicular to a radius of curvature of the capsule.

9. The system of claim 1, wherein the maximum accommodation of the eye is modeled as six diopters or more.

10. The system of claim 1, wherein the overall length of anterior zonules is modeled as the same for both distance and near positions.

11. The system of claim 1, wherein the volume of a lens capsule is modeled as constant.

12. A method of designing with a computerized model a pseudo-aphakic accommodative lens for insertion into a human eye comprising:
determining at least one characteristic of focal accommodation in the eye;
processing the at least one characteristic of the eye;
forming the computerized model of a accommodative intraocular lens (IOL); and
designing the pseudo-aphakic accommodative lens based on the model formed.

13. The method of claim 12, wherein at least one characteristic is chosen from an axial length of the eye, a position of the nucleus of a natural lens in the eye, a distance from the apex of the cornea of the lens, an index of curvature of the cornea, presence of scar tissue, and age and lifestyle of a patent.

14. The method of claim 12, wherein at least on characteristic is calculated mathematically from images of a human eye taken with imaging technology.

15. The method of claim 14, wherein the imaging technology is an MRI.

16. The method of claim 12, wherein the computerized model depicts movement of the human eye from a distance vision position to a near vision position.

17. The method of claim 16, wherein the computerized model comprises a plurality of graphic images.

18. The method of claim 17, wherein the plurality of graphic images depict changes in at least one of a ciliary body, a position of the zonules, and location and configuration of the natural lens as the eye moves from the distance vision position to the near vision position.

19. The method of claim 12, wherein a slope of a zonule at an attachment point to a capsule is modeled as tangential to a capsular arch at the attachment point and perpendicular to a radius of curvature of the capsule.

20. The method of claim 12, wherein the maximum accommodation of the eye is modeled at six diopters or more.

21. The method of claim 12, wherein the overall length of anterior zonules is modeled as the same for both distance and near positions.

22. The method of claim 12, wherein the volume of a lens capsule is modeled as constant.

23. A computer readable media containing program instructions for determining a computerized model that designs a pseudo-aphakic accommodative lens for insertion into a human eye, that causes a computer to:
obtain at least one characteristic of focal accommodation in the eye;
process the at least one characteristic of the eye; and
form the computerized model of a accommodative intraocular lens (IOL) based on the processed at least one characteristic of the eye.

24. The computer readable media of claim 23, wherein at least one characteristic is chosen from an axial length of the eye, a position of the nucleus of a natural lens in the eye, the distance from the apex of the cornea of the lens, the index of curvature of the cornea, the presence of scar tissue, and age and lifestyle of the patent.

25. The computer readable media of claim 23, wherein at least on characteristic is calculated mathematically from images of the human eye.

26. The computer readable media of claim 25, wherein the images of the human eye are taken with an MRI.

27. The computer readable media of claim 23, wherein the model depicts the movement of the eye from a distance vision position to a near vision position.

28. The computer readable media of claim 23, wherein the model comprises a plurality of graphic images.

29. The computer readable media of claim 28, wherein the plurality of graphic images depict changes in at least one of a ciliary body, a position of the zonules, and location and configuration of the natural lens as the eye moves from the distance vision position to the near vision position.

30. The computer readable media of claim 23, wherein a slope of a zonule at an attachment point to a capsule is modeled as tangential to a capsular arch at the attachment point and perpendicular to a radius of curvature of the capsule.

31. The computer readable media of claim 23, wherein the maximum accommodation of the eye is modeled at six diopters or more.

32. The computer readable media of claim 23, wherein the overall length of anterior zonules is modeled as the same for both distance and near positions.

33. The computer readable media of claim 23, wherein a volume of a lens capsule is modeled as constant.
